(19) United States
(12) Patent Application Publication
(10) Pub. No.: US 2019/0269128 A1
(43) Pub. Date: Sep. 5, 2019

(54) WATER BASED DISINFECTANT FORMULATION

(71) Applicant: Loxley House PTE LTD, Singapore (SG)

(72) Inventor: Donald Speak, Bangkok (TH)

(73) Assignee: Loxley House PTE LTD, Singapore (SG)

(21) Appl. No.: 16/343,707

(22) PCT Filed: Oct. 21, 2016
(86) PCT No.: PCT/IB2016/001537

§ 371 Date: Apr. 19, 2019

(51) Int. Cl. A01N 33/12

(52) U.S. Cl. CPC A01N 33/12; A01N 25/30

(57) ABSTRACT

The present invention relates to water based disinfectant formulation comprising Didecyldimethyl ammonium chloride as an active agent, Polyoxy ethylene cetyl steryl as de-foaming agent, Ethylenediamine as chelating agent. Potassium Carbonate as filler pH adjusting agent. Monoethanolamine as neutralizer, and Distilled water as solvent, provides immediate efficacy upon application and prolonged residual activity against broad spectrum of microbes. The formulation forms transparent water soluble film which do not cause any unsightly residues on applied surface, easily removed by warm water, and does not require special treatments and harsh chemicals for its complete removal. The present invention also provides a system and method of preparing disinfectant formulation.

### BACKGROUND

### Field

The present invention generally relates to anti-microbial disinfectant formulation and more particularly to water based anti-microbial disinfectant formulation, which provides immediate long lasting anti-microbial activity with no unsightly residue left upon application on surfaces.

### Description of Related Art

Antiseptics and disinfectants are used extensively in hospitals and other health care settings for a variety of topical and hard-surface applications. In particular, they are an essential part of infection control practices and aid in prevention of nosocomial infections. Mounting concerns over potential microbial contamination and infection risks in food and general consumer markets have also led to increased use of antiseptics and disinfectants by general public for personal commercial operations, including restaurants, nursing homes, hospitals, and laboratories. A wide variety of chemicals agents are used in disinfectants, many of which have been used for hundreds of years, including alcohols, phenols, iodine, and chlorine. Most of these active agents demonstrate broad-spectrum of anti-microbial activity and they are used to reduce microbes on living tissue or medical equipment and other inmate objects. However excessive uses of these products have prompted some speculation on development of microbial resistance in microbes. The mechanism of resistance to antiseptic and disinfectant solutions includes cellular impermeability, biofilm formation, efflux, and mutations at the target site or over expression at the target site. It has been also reported contaminated antiseptics and disinfectants exhibits decreased efficacy and effectiveness. With the emergence of pathogens such as Methicillin-resistance Staphylococcus aureus (MRSA), Vancomycin Resistant Entericocci (VRE) and Gram negative bacteria, for example, Pseudomonas aeruginosa and Acetobacter species which are resistant to multiple antibiotics, hence there is an increased need for effective antisepsis and disinfectant. Despite best efforts to eliminate these infectious micro organisms, they continue to emerge and re-emerge, contributing to human illness and death, especially as a result of infections acquired in the hospital. The successful eradication of these pathogens with antiseptic/disinfectant solutions have been complicated by development of highly resistant strains. It has been also reported that disinfectant designed for control of micro-organisms are subjected to microbial contamination. Clostridium difficile is an obligate anaerobic, spore-producing, gram-positive rod bacterial pathogen in 20% to 30% of patients with antibiotic-associated diarrhea, 50% to 75% of those with antibiotic-associated colitis, and more than 90% of those with antibiotic-associated pseudomembranous colitis, Clostridium difficile infection (CDI) is a hospital-acquired infection associated with an increase in length of hospital stay and cost, and substantial morbidity and mortality.

The most common disinfection method for water treatment is chlorination; however, it has been known that practice of chlorination for water treatment in the Mississippi river area has caused a significant increase in mortality. In hospitals and for general disinfection in an area, the chlorine containing compounds are used as disinfecting cleaning agents on surfaces and items such as floors, bed frames, bathrooms, bed pans, human waste matter, body fluids. Product brand names include Oxi-Clean, Ajax, Lysol, Soft-Scub, Clorex, Clorox, all of these products are bleach based and none of these products kill endospores. Glutaraldehyde is used to disinfect instruments and appliances. This substance is diluted with water, however Glutaraldehyde kills endospores, but it is highly toxic and strong irritant. Hydrogen Peroxide is diluted with water, used as a disinfectant, but it has a pungent odor and has limited application and uses, and also does not kill endospores. It is also highly toxic and dangerous to the end user; product brand names include Interox, Solway. Povidione Iodine is used as a broad spectrum anti-septic agent and disinfectant but it has limited uses, not suitable for use on surfaces and does not kill Endospores. Product brand names include Polyvidon, PVP Iodine, Betadine, and Pyodine. Povidione Iodine Chlorhexidine preparation used as an antiseptic solution for cleaning road side accident wounds and wounds in general, product brand names include Cetavlon, Savlon, and Cetrimide. Over 90% of all disinfectants are solvent; alcohol and bleach based products and have environmental waste management issues.

In recent years there has been considerable concern over the diseases and allergies spread by the micro-organisms such as bacteria's, fungi and protozoa's which breed in air-conditioning systems and cooling towers under certain conditions. Hundreds of cases are recorded worldwide each year of Legionnaires' disease, which is caused by inhaling contaminated air and water from the air-conditioning systems and showers respectively. At the present time for preventing these diseases the conventional practice is to regularly clean the filter, which are costly and labor intensive.

Researchers have found the increased use of low-temperature washes and gentle detergents to be culprits of laundry bacteria in washing machines. The researchers examined the bacteria levels found in clean laundry and the potential risk of infections from wearing this laundry. Clean undergarments were found to be the main carriers of fecal matter, as well as germs including hepatitis A virus, Norovirus, Rotavirus, Salmonella, and E. coli, mild spores, which can multiply into fungus. Underwear, towels, and face cloths, among other items found to be contaminated with pathogens bacteria that can cause disease. A load of underwear during a wash can contain approximately 100 million E. coli and can then cross-contaminate next load of laundry.

In animal husbandry sector, Equine Flu is a highly contagious viral disease of the respiratory tract and it spread from horse to horse in variety of ways, breathing air that has been contaminated with breath exhaled from an infected animal; contaminated surfaces in stables, loose boxes and horse boxes; equipment, rugs or tack that has been used on an infected horse, the disease is very contagious and there is almost a 100% infection rate in a population that has been previously unexposed to the virus.

Some types of hard surfaces such as ceramics, floor tiles, metal surfaces and glasses present a problem of developing a layers of unsightly residues left on surfaces after using disinfectants, which deteriorate visible appearance. Rinsing the surface with fresh water after cleaning would remove these unsightly residues, but this step adds additional work of cleaning process and wastage of water. Thus, there exists a need for developing disinfecting formulations which can be used on various hard surfaces, especially glass, ceramic and polished metals, without leaving unsightly residues.

In order to ameliorate the discussed disadvantages of the disinfectants and to minimize the deleterious effect of disinfectants on surfaces and cost, it is desirable to minimize the amount of unsightly residues left on surfaces after cleaning and to control the hazardous effect of solvent based disinfectants.

There is need to develop a biodegradable, non-toxic, environment friendly, safe and cost-effective water based anti-microbial broad spectrum disinfectant formulation having immediate and long lasting activity against broad spectrum of microbes.

### SUMMARY

The primary objective of the present invention is to provide a biodegradable, non-toxic, environment friendly, safe and cutting edge multipurpose water based anti-microbial broad spectrum disinfectant formulation having immediate and residual unique long lasting activity against broad spectrum of microbes such as but not limited to bacterial strains, viruses, endospores, molds, yeast, algae and fungi.

Another objective of the present invention is to provide simple water based, non-toxic, environment friendly, cost-effective anti-microbial disinfectant formulation for washing down pens, machinery, farming equipment and vehicles preventing the spread of serious agricultural pathogens and effective against pathogens prevailing in the animal husbandry sector such as but not limited to foot and mouth and H5NI bird flu in stable blocks or areas where animals are bred.

Yet another objective of the present invention is to provide a disinfectant formulation which can be defused to decontaminate closed area either by atomizing or incorporated in air-conditioning units and de-humidifier units to combat air-borne pathogens such as but not limited to Influenza, Equine influenza, flu.

Another objective of the present invention is to provide a water-based disinfectant formulation to disinfect surfaces such as bathroom, toilet areas, ceramic tiles, glass mirrors, bathroom, floor areas, wooden surfaces, stainless steel, chrome wear and fittings, plastic surfaces & items, kitchens and food preparation areas.

Another objective of the present invention is to provide a non-irritant and non-flammable disinfectant formulation which can be used by incorporating in diffuser, atomizer, sprayer, and scrubber and or by directly applying on hard surfaces, substrate, materials, and fabrics leaving natural and fresh odor.

Another objective of the present invention is to provide water based anti-microbial hospital grade disinfectant sanitizer, antiseptic effective against microbes and resistant microbes found in the hospitals.

Another objective of the present invention is to provide water based disinfectant with a high pH value, quick action time, and efficacy over prolonged periods.

Another objective of the present invention is to provide water based anti-microbial water and waste treatment product killing microbes prevailing and leaving fresh and natural odor.

Another objective of the present invention is to provide water based disinfectant formulation which can be applied including shoe wear sanitizer, laundry additive, nasal sprays, veterinary sterilizer, and water based acrylic coating.

According to one aspect of the present invention is to provide water based disinfectant formulation comprising Didecyl dimethyl ammonium chloride as active agent, Polyoxy ethylene cetyl steryl as de-foaming agent, Ethylenediamine as chelating agent, Potassium Carbonate as filler or pH adjusting agent, Monoethanolamine as pH adjuster or neutralizer, and Distilled water as solvent, which can be applied to substrates, surfaces, materials, and fabrics.

According to another aspect of the present invention is to provide a formulation which forms a transparent anti-microbial film, following application and upon natural drying, provides immediate and prolonged residual anti-microbial activity over an extended period of time against broad spectrum of microbes such as but not limited to bacterial strains, viruses, endospores, molds, yeast, algae and fungi.

According to yet another aspect of the present invention is to provide water based disinfectant formulation comprising 12.50% by weight Didecyl dimethyl ammonium chloride, 5.00% Polyoxy ethylene cetyl steryl, 6.0% by weight Ethylenediamine, 5.0% Potassium Carbonate, 8.0% by weight Monoethanolamine and 63.50% by weight Distilled water, based upon 100% total weight of composition.

According to still another aspect of the present invention is to provide pH value of Didecyl dimethyl ammonium chloride, Monoethanolamine, Potassium Carbonate, and Distilled water is 6.9, 11.8, 11.5 and 7.0 respectively.

According to another aspect of present invention is to provide, an insecticidal formulation comprising 12.50% by weight Didecyl dimethyl ammonium chloride, 5.00% Polyoxy ethylene cetyl steryl, 6.0% by weight Ethylenediamine, 5.0% Potassium Carbonate, 8.0% by weight Monoethanolamine, 3% by weight Permithrin and 60.50% by weight Distilled water, based upon 100% total weight of composition.

According to yet another aspect of the present invention is to provide, a system for preparing the disinfectant formulation. The system comprising vessel A and vessel B, material drainage tube connecting both vessel A and vessel B, pump to transfer the mixed components from vessel A to Vessel B and material release valve in vessel B to decant the prepared formulation. The Vessels are double walled and have mixing paddles situated at the base of vessels for mixing the components. Vessel B has temperature control heating mechanism situated within the double wall of the vessel allowing temperature variation and control within the vessel. Vessel B also has a releasing valve for decanting the prepared formulation. Both mixing vessels are housed on a large platform, which is approximately one meter high from the floor.

According to another aspect of present invention, material drainage tube of 50 mm is connected between vessels.

According to another aspect of the present invention, the mixing vessels are made up of stainless steel material.

According to yet another aspect of the present invention, a process for preparing the disinfectant formulation comprising two stages:

In stage one, firstly Distilled water is added in vessel A, followed by Potassium Carbonate, followed by Polyoxy ethylene cetyl steryl, followed by Ethyldiamine and Monoethanolamine at predetermined stage and mixed together at ambient temperature by rotating the mixing paddles in vessel A and then transferred to vessel B via the material drainage tube.

In stage two, the transferred liquid is heated to a specific temperature then Didecyl dimethyl ammonium chloride is added and mixed together by rotating the mixing paddles in vessel B, allowed to return at ambient temperature after thorough mixing.

According to still another aspect of present invention there is provided, the temperature setting of vessel B is in range of 50° C. to 60° C.

According to another aspect of present invention, the speed of rotation of mixing paddles of vessel A and vessel B is 55 revolutions per minutes.

According to yet another aspect of the present invention, a method of disinfecting a surface comprising applying a disinfectant formulation on substrates, surfaces, materials, and fabrics forming a water soluble transparent anti-microbial layer.

These and other advantages will be apparent from the present application of the embodiments described herein.

The preceding is a simplified summary to provide an understanding of some aspects of embodiments of the present invention. This summary is neither an extensive nor exhaustive overview of the present invention and its various embodiments. The summary presents selected concepts of the embodiments of the present invention in a simplified form as an introduction to the more detailed description presented below. As will be appreciated, other embodiments of the present invention are possible utilizing, alone or in combination, one or more of the features set forth above or described in detail below.

### BRIEF DESCRIPTION OF THE DRAWINGS

The above and still further features and advantages of embodiments of the present invention will become apparent upon consideration of the following detailed description of embodiments thereof, especially when taken in conjunction with the accompanying drawings, and wherein:

FIG. 100 illustrates a system for preparing the disinfectant formulation in the present invention

The headings used herein are for organizational purposes only and are not meant to be used to limit the scope of the description or the claims. As used throughout this application, the word “may” and “can” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

The present invention relates to water based disinfectant formulation comprising Didecyl dimethyl ammonium chloride as active agent, Polyoxy ethylene cetyl steryl as de-foaming agent, Ethylenediamine as chelating agent, Potassium Carbonate as filler pH adjusting agent, Monoethanolamine as neutralizer, and Distilled water as solvent, which can be applied to substrates, surfaces, materials and fabrics. When the disinfectant formulation is applied to substrates, surfaces, materials, fabrics, it forms an antimicrobial transparent wet film following the natural drying process. The antimicrobial transparent dry film in turn protects the substrates and produces a barrier so that microbes cannot propagate. The film produced is effective against broad range of microbes and provides antimicrobial performances for prolonged period. The composition is active in and on both surface bourn and air bourn environments. The disinfectant formulation carries a positive charge and microbes carries negative charge, so when contaminated substrates, surfaces, materials and fabrics are challenged by disinfectant formulation, the charge distribution of membrane changes which leads to cell wall disruption and thus killing the microbes instantaneously.

Embodiments in accordance with the present invention, the disinfectant formulation comprising 12.50% by weight Didecyl dimethyl ammonium chloride, 5.00% by weight Polyoxy ethylene cetyl steryl, 6.0% by weight Ethylenediamine, 5.0% by weight Potassium Carbonate, 8.0% by weight Monoethanolamine and 63.50% by weight Distilled water, based upon 100% total weight of composition. Embodiments in further accordance with the present invention, the pH value of Didecyl dimethyl ammonium chloride, Monoethanolamine, Potassium Carbonate, and Distilled water is 6.9, 11.8, 11.5, and 7.0 respectively resulting in a high pH factor formulation which harnesses its pH value and used to kill microbes.

Embodiments in accordance with the present invention, the buffering components used in the disinfectant formulation for maintaining the pH of the solution are selected from a group metal carbonates. The buffering component used is Potassium Carbonate, which maintains the pH of the formulation. Further embodiments of the present invention, the de-foaming agents are used to reduce the foam formation and increase the stability and efficiency of the process are selected from a group of polyoxyethylene ether. A pharmaceutically acceptable non-ionic surfactant, defoamer is polyoxy ethylene cetyl stearyl, ceteryl-25. Further embodiment of the present invention, a chelating agent is used to bind the molecules together. The Ethylenediamine is used as chelating agent. In further embodiments of the present invention, the Didecyl dimethyl ammonium chloride is used as active ingredient in the formulation, which is bactericidal component in the formulation.

Embodiments in accordance with the present invention, a insecticidal formulation comprising 12.50% by weight Didecyl dimethyl ammonium chloride, 5.00% Polyoxy ethylene cetyl steryl, 6.0% by weight Ethylenediamine, 5.0% Potassium Carbonate, 8.0% by weight Monoethanolamine, 3% by weight Peiinithrin and 60.50% by weight Distilled water, based upon 100% total weight of composition. The Permithrin is an active ingredient that is added to detour the pest and insects.

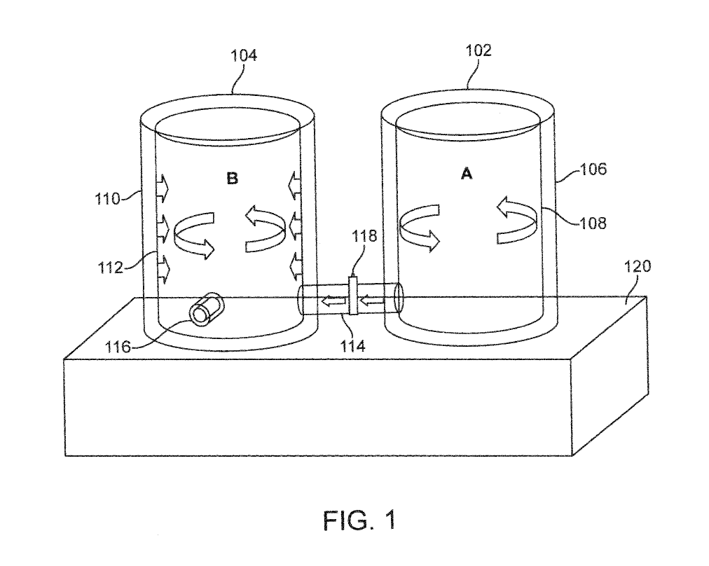

Embodiments in accordance with the present invention and referring to FIG. 100, a system for preparing the disinfectant formulation is described. The system comprises mixing vessels, vessel A (102) and vessel B (104), a material drainage tube (114) connecting both vessel A (102) and vessel B (104), a pump (118) to transfer the mixed components from vessel A (102) to vessel B (104) and a material release valve (116) in vessel B (104) to decant the prepared formulation. The vessels (102, 104) are double walled having outer (106, 110) and inner (108, 112) layers and made up of stainless steel material. The capacity of mixing vessels is 1000 liters. The mixing vessels (102, 104) also have mixing paddles situated at the base of vessels for mixing the formulation's components. The vessel B (104) has temperature control heating mechanism situated within the double wall of the vessel allowing temperature variation and control within the vessel. The vessel B (104) also has a releasing valve for decanting the prepared formulation. Both mixing vessels are housed on a large platform (120), which is approximately 1 meter high from the floor for maintenance and cleaning.

Embodiments in accordance with the present invention, the disinfectant formulation is prepared by a process comprising two stages: In stage one, firstly distilled water is added in vessel A (102) followed by Potassium Carbonate, followed by Polyoxy ethylene cetyl steryl, followed by Ethyldiamine and Monoethanolamine at predetermined stage and mixed together at ambient temperature by rotating the mixing paddles in vessel A and then transferred to vessel B (104) via the material drainage tube (114). In stage two, the transferred components are heated to 50° C.-60° C. then Didecyl dimethyl ammonium chloride is added and mixed together by rotating the mixing paddles in vessel B (104), allowed to return at ambient temperature after thorough mixing.

Further embodiments in accordance with the present invention, the disinfectant formulation can be incorporated in many applications and industries including but not limited to general purpose disinfectant/sanitizer, kitchen appliance sanitizer, pharmaceuticals preparations, shoe sanitizer, air conditioning sanitizer, laundry sanitizer, washing machine sanitizer, grease trap treatment additive, waste treatment additive, water treatment additive, drain treatment additive, dumpster treatment, composite materials additive, pest control products, foam sanitizer, and veterinary products and applications, air quality additive.

Further embodiments in accordance with the present invention, the method of disinfecting a substrate comprising applying a comprising formulation. In exemplary embodiment of the present invention, the substrate is a hard surface, soft surface, materials, and fabrics. Substrates, which may be disinfected with the compositions, include, but are not limited to, those located in dairies, homes, hospitals, swimming pools, changing rooms, shower areas, cloth lockers, changing benches, canneries, food processing plants, restaurants, institutions, and industry, animal husbandry sectors, and stable blocks. Hard surfaces, such as glass polished aluminum, stainless steel, chrome fittings and metallic surfaces are particularly suited for application. Specific areas targeted for application include hard surfaces in the home such as kitchen countertops, cabinets, appliances, waste cans, laundry areas, garbage pails, bathroom fixtures, toilets, water tanks, faucets, mirrors, vanities, tubs, and showers. The formulation can also be used to sanitize floors, walls, furniture, minors, toilet fixtures, windows, wood surfaces, such as fence rails, porch rails, decks, roofing, siding, window frames, and door frames. The formulation is particularly well suited for application on indirect food contact surfaces, such as cutting boards, utensils, containers, dishes, washbasins, appliances, and countertops. The formulation can be used to sanitize diary plant equipment, milking machines, milk pails, tank trucks, and the like. Areas in hospitals would include beds, gurneys, tables, canisters, toilets, waste cans, stands, cabinets, shower stalls, floors, walls or any other non-porous surface. The formulation can also be used to disinfect fabrics including but not limited to carpets, mats, clothes, apparels, and towels. The formulation can also be applied to materials such as but not limited to rubber, plastics, steels, and wooden boards.

Further embodiments in accordance with the present invention, the formulation may be applied to surfaces, substrates by any method including but not limited to wiping, mopping, brushing, spraying, soaking, aerosolizing, flooding, atomizing, foaming, diffusing and like. For example, the composition may be absorbed in wipes and used to clean kitchen surfaces or floors. In an exemplary embodiment the formulation used in the form including but not limited to foams, gels, aerosols, additives.

Further embodiments in accordance with the present invention, the composition is in form of concentrate, where it is diluted with the water according to the area of application. The disinfectant formulation may be applied by any method such as spraying, wiping, aerosolizing and like to destroy broad range of microbes such as not limited to bacterial strains, viruses, fungi, molds, yeast, algae and endospores. Bacterial strains including Gram positive and Gram negative bacteria such as but not limited to Actinomyces, Bacillus, Clostridium, Corynebacterium, Enterococcus, Gardnerella, Lactobacillus, Listeria, Mycobacterium, Mycoplasma, Nocardia, Propionibacterium, Staphylococcus, Streptococcus, Streptomyces, Borrelia, Bortadella, Burkholderia, Campylobacter, Chlamydia, Enterobacter, Escherichia, Fusobacterium, Helicobacter, Hemophilus, Klebsiella, Escherichia coli, Staphylococcus aureus, Salmonella choleroesusis, Trichophyton mentagrophytes. Viruses including enveloped and non enveloped viruses such as but not limited to Avian Flu H5N1, Equine Influenza.

In an exemplary embodiment, a ventilation and air-conditioning sanitizer is formed by incorporating the disinfectant formulation in the spraying devices such as but not limited to sprayer, diffuser, foam gun, gel and sprayed over the filter units of air-conditioners to combat bacterial growth and allow the product to dry on filters for prolonged residual activity. The formulation following application also assists in preventing the formulation of bio-film on surfaces, which create a sticky substance and allow bacteria to propagate.

In another exemplary embodiment of the present invention, the formulation is incorporated in pharmaceuticals preparations such as but not limited to nasal sprays for treating methicillin resistant Staphylococcus aureus infections in respiratory tract. In yet another exemplary embodiment of the present invention, the formulation may be incorporated in personal hygiene products such as but limited to shampoos, conditioners, shower gels, hand wash gel, sanitizers, foot spa additive, face mask additive and antiseptic additive. In another embodiment of the present invention, a shoe wear sanitizer is formed by diluting the disinfectant formulation by 1% to the total weight of the composition. The shoe wear sanitizer may be directly applied to the inner surface of the shoe without degrading the shoe materials. The shoe wear sanitizer kills bacteria's and leaves natural odor upon application.

In another exemplary embodiment of the present invention, the formulation may be used in Spa environment for addressing laundry issues at source by forming laundry additive or adding it in washing machine directly. A laundry additive is formed by diluting the disinfectant formulation by 5% to the total weight of the composition. The laundry sanitizer may be used as an additive in the washing machine. The additive increases the pH value of the washing water, sanitizes the cloths against microbes such as but not limited to E. coli, Salmonella, fecal bacteria, mildew and molds including towels without affecting the material and color fade.

In yet another exemplary embodiment of the present invention, the formulation can be used as water treatment additive for treating the water and kill bacteria and algae in the water and making it suitable for drinking purposes.

In still another exemplary embodiment of the present invention, the formulation may be also used in blocked areas such as but not limited to traps, drains, pipes, grease traps, septic systems, sewage systems, and anaerobic digestion systems. For example, the formulation when added to a grease trap, it solubilizes grease, fats, oils, starches, proteins and cellulose as it has high pH factor thus helping to digest organic matter without damaging the plastic components and also controls the pungent odor emitting from the equipments.

In another exemplary embodiment of the present invention, the formulation is used as additive by incorporating it in composites; water based acrylic coating or other pest control products. In yet another exemplary embodiment of the present invention, the water based clear acrylic coating containing additive within the formulation, which can be applied by brush, roller or spray unit that protects, sanitizes, disinfects and detours insect pests. Following application and surface drying process, the additive which is contained and capsulated within the coating, is released through the formulation's micro porous, permeable structure dry film out to atmosphere, creating a sanitized surface which is also insecticidal without creating any health risks to humans or animals. The dry film creates sanitized and insecticidal surfaces.

In still another exemplary embodiment of the present invention, the formulation is incorporated in veterinary products such as but not limited to dog shampoo, soaps, gel, and sanitizer. In another exemplary embodiment, the formulation can be used for washing down including stable blocks, machinery, equipments, and vehicles. It can also be incorporated in dehumidification system and air-conditioning units of large farms where animals are bred or kept in close proximity, for preventing spread of serious pathogens such as but not limited to Equine influenza, Foot and mouth, H5N1 Bird Flu, Swine vesicular disease, Brucellosis. In yet another exemplary embodiment, the formulation is used as veterinary sterilizer which is a box containing a wick impregnated with product solution and a battery operated fan that blows air in direction of the box. The unit can be placed in boxes including stable or loosebox or travelling boxes when transporting horses. The veterinary sterilizer sterilizes a space of 50 cubic meters in three hours and give continues protection against any viruses or bacteria that enter the air space while the equipment is working.

In another exemplary embodiment of the present invention, the formulation is applied as foaming nozzle gun. The foaming nozzle gun comprises high pressure water jet, concentrate inlet, and a material suction pick up tube which draw concentrate product into the gun armature to be mixed with the water jet then creates dense antimicrobial foam for addressing any pungent odor problems and micro-organisms effectively and safely, therefore the product can be applied in many situations including but not limited to food processing and production, markets including pungent odors and microbes from fish processing facilities and many other fit for purpose applications.

The following examples are illustrative of the present invention, however, it will be understood that the invention is not limited to the specific details set forth in the examples.

### EXAMPLE 1

### Preparation of Disinfectant Formulation

A disinfectant formulation comprising 12.50% by weight Didecyl dimethyl ammonium chloride, 5.00% Polyoxy ethylene cetyl steryl, 6.0% by weight Ethylenediamine, 5.0% Potassium Carbonate, 8.0% by weight Monoethanolamine and 63.50% by weight Distilled water based upon 100% total weight of composition was prepared as follows:

To prepare 100% total weight of composition, firstly 63.50% by weight Distilled water was taken in vessel, then 5.0% Potassium Carbonate used as pH adjusting agent was added, then 5.00% Polyoxy ethylene cetyl steryl (ceterath-25) used as emulsifier was added, and then 6.0% by weight Ethylenediamine used as chelating agent was added, followed by 8.0% by weight Monoethanolamine (99%, AI 7.920) used as neutralizer were added at a predetermined stage and were mechanically mixed together at ambient temperature by rotating mixing paddles in the vessel A at 55 revolutions per minute and then the mixed components were transferred to another vessel B which was inter connected by a 50 mm connecting tube from vessel A. The ingredients were heated at 55° C. and then 12.50% by weight Didecyl dimethyl ammonium chloride (80%. AI 10.00%) was added and mixed thoroughly. After mixing, the mixture is allowed to cool down at ambient temperature and prepared disinfectant formulation decanted through release valve in vessel B.

### EXAMPLE 2

### Dilution of Disinfectant Formulation for Using on Floors and Hard Surfaces

50 ml of concentrate disinfectant formulation was taken in 2 litres of clean water. The disinfectant formulation cleans the dust, debris, stubborn stains and grease,

### EXAMPLE 3

### Dilution of Disinfectant Formulation for Using in Pumps and Sprays

1 ml of concentrate disinfectant formulation was taken in 1 litre of water. The disinfectant formulation effectively killed the bacteria's, fungi, molds, and yeast on spraying.

### EXAMPLE 4

### Effect of Disinfectant Formulation of Product Swab Testing in Meat Processing Facility on Surfaces

The disinfectant formulation was diluted to 1:10 water concentrate solution and tested over the floors. According to appendix 1, the concentration of Bacillus cereus, E. coli, Pseudomonas aeruginosa and Clostridium was <10 CFU/100 cm², 80 CFU/100 cm² and null of other two micro organisms respectively before applying the disinfectant or Pre-Floor. After applying the disinfectant formulation the concentration of E. coli reduced to <10 CFU/100 cm², thus there is considerable reduction in microbe concentration. Refer to appendix 1 and appendix 2 for results.

### EXAMPLE 5

### Effect of Disinfectant Formulation of Product Swab Testing in Meat Processing Facility on Equipments.

The disinfectant formulation was diluted to 1:10 water concentrate solution and tested over the cutting-boards. According to appendix 3, before applying the disinfectant on cutting board, the concentration of Bacillus cereus, E. coli, Pseudomonas aeruginosa and Clostridium was <10 CFU/100 cm², 1.0×10² CFU/100 cm² and null for other two micro organisms respectively. After applying the disinfectant formulation the concentration of E. coli was reduced to <10 CFU/100 cm², thus there is considerable reduction in microbe concentration. Refer to appendix 3 and appendix 4 for results.

### EXAMPLE 6

### Result of Efficiency Testing of Micro-Organisms Sterilizing

The disinfectant formulation was diluted to 1:20 and applied to bacterial contaminated carriers for 10 minutes. The bacterial strains Staphylococcus aureus (ATCC 6538), Salmonella choleroesusis (ATCC 10708) and Trichophyton mentagrophytes which were a clinical isolate were destroyed in 60 seconds. The tests were carried out at the Mahidol University Quality Assurance Project (Microbiology) Faculty of Medical Technology Thailand and refer to appendix 5 for results.

### EXAMPLE 7

### Disinfectant Formulation Kills Avian Flu H5N1

According to the Animal Disease Autopsy Sub-section (Kamphaeng Saen) Veterinary Academic Research and Service Center Faculty of Veterinary Science Kasetsart University Thailand, the disinfectant formulation kills Avian Flu H5N1 in 60 seconds and sterilizes 50 cubic meter area in three hours. The International guideline protocol states that this virus should be killed within a 10-minute time frame, this formulation killed this virus in less than 1 minute, and therefore this means the formulation exhibits extremely fast action time frame.

### EXAMPLE 8

### Safety Report of Disinfectant Formulation

According to the Department of Medical Science Ministry of Public health, Thailand; the disinfectant formulation meets the Bureau of Cosmetics and Hazardous Substance Control. The

1. A disinfectant formulation comprising Didecyl dimethyl ammonium chloride, Polyoxyethylene cetyl/stearyl, Ethylenediamine, Potassium Carbonate, Monoethanolamine, and Distilled water.

2. The disinfectant formulation as claimed in claim 1, wherein the formulation comprises 12.50% by weight Didecyl dimethyl ammonium chloride, 5.00% by weight Polyoxyethylene cetyl/stearyl, 6.0% by weight Ethylenediamine, 5.0% by weight Potassium Carbonate, 8.0% by weight Monoethanolamine and 63.50% by weight Distilled water based upon 100% total weight of composition.

3. The disinfectant formulation as claimed in claim 1, wherein the formulation comprises 12.50% by weight Didecyl dimethyl ammonium chloride, 5.00% by weight Polyoxyethylene cetyl/stearyl, 6.0% by weight Ethylenediamine, 5.0% by weight Potassium Carbonate, 8.0% by weight Monoethanolamine, 3% by weight Permithrin and 60.50% by weight Distilled water based upon 100% total weight of composition.

4. The disinfectant formulation as claimed in claim 1, wherein the Didecyl dimethyl ammonium chloride is an active agent, wherein the Polyoxyethylene cetyl/stearyl is a de-foaming agent, wherein the Ethylenediamine is a chelating agent, wherein the Potassium Carbonate is a pH adjusting agent, wherein the Monoethanolamine is a neutralizer, and wherein the Distilled water is a solvent.

5. (canceled)

6. (canceled)

7. (canceled)

8. (canceled)

9. (canceled)

10. The disinfectant formulation as claimed in claim 1, where in the pH value of Didecyl dimethyl ammonium chloride, Monoethanolamine, Potassium Carbonate, and Distilled water prior to addition to the formulation is 6.9, 11.8, 11.5 and 7.0 respectively.

11. The disinfectant formulation as claimed in claim 1, wherein the response time of disinfectant formulation is 60 seconds.

12. The disinfectant formulation as claimed in claim 1, wherein the pH value of disinfectant formulation is 12.9.

13. The disinfectant formulation as claimed in claim 1, wherein the formulation upon application and naturally drying creates a residual activity which in turn creates a microbial free surface.

14. The disinfectant formulation as claimed in claim 1, wherein the formulation upon application prevents the formulation of bio-film on surfaces.

15. A system for preparing the disinfectant formulation of claim 1 housed on a large platform comprising (a) vessel A and vessel B, (b) material drainage tube connecting both vessel A and vessel B, (c) mixing paddles at the base of vessels for mixing, (d) pump to transfer the mixed components from vessel A to vessel B, (d) material release valve in vessel B to decant the prepared formulation.

16. The system for preparing the disinfectant formulation as claimed in claim 15, wherein the mixing vessels are made up of stainless steel material.

17. The system for preparing the disinfectant formulation as claimed in claim 15, wherein the mixing vessels are double walled or twin skinned.

18. The system for preparing the disinfectant formulation as claimed in claim 16, wherein the diameter of material drainage tube is 50 mm.

19. The system for preparing the disinfectant formulation as claimed in claim 15, wherein Vessel B has temperature control heating mechanism within the double wall of the vessel allowing temperature variation and control within the vessel.

20. A process for preparing the disinfectant formulation of claim 1 comprising two stages:
(i) Distilled water is added in vessel A followed by Potassium Carbonate, followed by Polyoxyethylene cetyl/stearyl, followed by Ethyldiamine and Monoethanolamine at predetermined stage and mixed together at ambient temperature by rotating the mixing paddles of vessel A and then transferred to vessel B via the material drainage tube;
(ii) the transferred liquid from vessel A are heated in vessel B then Didecyl dimethyl ammonium chloride is added and mixed together by rotating the mixing paddles in vessel B, allowed to return at ambient temperature after thorough mixing.

21. The process as claimed in claim 20, wherein the temperature setting of vessel B at which the mixture is heated is in range of 50° C.-60° C.

22. The process as claimed in claim 20, wherein the speed of rotation of mixing paddles of vessel A and vessel B is 55 revolutions per minutes.

23. A method of disinfecting a surface comprising applying the disinfectant formulation of claim 1 on substrates, surfaces, materials, and fabrics which forms a transparent anti-microbial layer, upon application followed by drying provides immediate and prolonged activity against broad spectrum of microbes.

24. The method of disinfecting a surface of claim 23, wherein the disinfectant formulation can be applied by moping, wiping, spraying, flooding, atomizing, foaming, defusing surfaces, substrates, materials and fabrics.

25. The method of disinfecting a surface of claim 23, wherein the disinfectant formulation is applied as ventilation sanitizer, air-conditioning sanitizer, laundry sanitizer, shoe wear sanitizer, veterinary sterilizer, water acrylic coating surfaces, grease entrapper, foaming nozzle gun, nasal sprays, water treatment additive.

26. The method of disinfecting a surface of claim 23, wherein the disinfectant formulation is incorporated in personal hygiene and veterinary products.
